(19) United States
(12) Patent Application Publication
(10) Pub. No.: US 2026/0312755 A1
(43) Pub. Date: Oct. 8, 2026

(54) METHOD FOR SENDING INFORMATION, METHOD FOR RECEIVING INFORMATION, AND COMMUNICATION DEVICE

(71) Applicant: BEIJING XIAOMI MOBILE SOFTWARE CO., LTD., Beijing (CN)

(72) Inventors: Yuxin MAO, Beijing (CN); Jianning LIU, Beijing (CN)

(73) Assignee: BEIJING XIAOMI MOBILE SOFTWARE CO., LTD., Beijing (CN)

(21) Appl. No.: 19/482,914

(22) PCT Filed: May 11, 2023
(86) PCT No.: PCT/CN2023/093711

§ 371 Date: Nov. 10, 2025

(51) Int. Cl. H04L 5/00; H04W 4/12; H04W 4/20

(52) U.S. Cl. CPC H04L 5/0048; H04W 4/12; H04W 4/20

(57) ABSTRACT

A method for sending information, a method for receiving information, an apparatus, a device, and a storage medium are provided. The method performed by a first terminal includes: in response to determining that a first condition is met, sending additional information to a second terminal in a unicast manner.

### CROSS-REFERENCE TO RELATED APPLICATIONS

The present application is a U.S. National Phase of International Application No. PCT/CN2023/093711, filed on May 11, 2023, the entire content of which is incorporated herein by reference for all purposes.

### FIELD

The present disclosure relates to the field of communication technologies, and in particular, to a method for sending information, a method for receiving information, an apparatus, a device, and a storage medium.

### BACKGROUND

Proximity services (ProSe) are device-to-device (D2D) technologies that allow wireless devices to detect each other and communicate directly. A ProSe user equipment-to-network relay (for example, ProSe UE-to-Network Relay) can provide a function to support a remote terminal in connecting to a network, where the remote terminal may be, for example, a Remote UE, which is a terminal supporting ProSe. The remote terminal can communicate with the network via the ProSe user equipment-to-network relay, where the network may be a fourth generation mobile communication technology (4G) network, a fifth generation mobile communication technology (5G) network, or any communication network. Discovery of the ProSe user equipment-to-network relay terminal can be implemented through two modes. In one mode (for example, Mode A), the ProSe user equipment-to-network relay terminal can broadcast its own terminal information for use by other terminals, and the remote terminal detects relevant messages to achieve discovery of the ProSe user equipment-to-network relay terminal. In another mode (for example, Mode B), the remote terminal can initiate a discovery request for the ProSe user equipment-to-network relay terminal based on a request to send information of another terminal from which a response is expected, that is, information of the requested ProSe user equipment-to-network relay terminal, and a qualified ProSe user equipment-to-network relay terminal responds to the corresponding request. In application scenarios of proximity services, additional information is often required to assist in communication.

In related art, additional information is usually sent based on Mode A, and for cases where Mode A is not used, effective sending of additional information cannot be supported.

### SUMMARY

In a first aspect, an embodiment of the present disclosure provides a method for sending information, performed by a first terminal, where the method includes: in response to determining that a first condition is met, sending additional information to a second terminal in a unicast manner.

In a second aspect, an embodiment of the present disclosure provides a method for receiving information, performed by a second terminal, where the method includes: receiving additional information sent by a first terminal in a unicast manner.

In a third aspect, an embodiment of the present disclosure provides a communication apparatus, where the communication apparatus has some or all functions of the first terminal in the method of the first aspect described above. For example, the functions of the communication apparatus may include some or all functions in the embodiments of the present disclosure, or may include functions for individually implementing any one embodiment of the present disclosure. The functions may be implemented by hardware, or by hardware executing corresponding software. The hardware or software includes one or more units or modules corresponding to the functions described above.

Optionally, in an embodiment of the present disclosure, the structure of the communication apparatus may include a transceiver module and a processing module, where the processing module is configured to support the communication apparatus in performing corresponding functions in the method described above. The transceiver module is used to support communication between the communication apparatus and other devices. The communication apparatus may further include a storage module, where the storage module is coupled to the transceiver module and the processing module, and stores necessary computer programs and data for the communication apparatus.

As an example, the processing module may be a processor, the transceiver module may be a transceiver or a communication interface, and the storage module may be a memory.

In a fourth aspect, an embodiment of the present disclosure provides another communication apparatus, where the communication apparatus has some or all functions of the second terminal in the method example of the second aspect described above. For example, the functions of the communication apparatus may include some or all functions in the embodiments of the present disclosure, or may include functions for individually implementing any one embodiment of the present disclosure. The functions may be implemented by hardware, or by hardware executing corresponding software. The hardware or software includes one or more units or modules corresponding to the functions described above.

Optionally, in an embodiment of the present disclosure, the structure of the communication apparatus may include a transceiver module and a processing module, where the processing module is configured to support the communication apparatus in performing corresponding functions in the method described above. The transceiver module is used to support communication between the communication apparatus and other devices. The communication apparatus may further include a storage module, where the storage module is coupled to the transceiver module and the processing module, and stores necessary computer programs and data for the communication apparatus.

In a fifth aspect, an embodiment of the present disclosure provides a communication apparatus, where the communication apparatus includes a processor, and when the processor invokes a computer program in a memory, the method for sending information of the first aspect described above is executed.

In a sixth aspect, an embodiment of the present disclosure provides a communication apparatus, where the communication apparatus includes a processor, and when the processor invokes a computer program in a memory, the method for receiving information of the second aspect described above is executed.

In a seventh aspect, an embodiment of the present disclosure provides a communication apparatus, where the communication apparatus includes a processor and a memory, where the memory stores a computer program; and the processor executes the computer program stored in the memory to cause the communication apparatus to perform the method for sending information of the first aspect described above.

In an eighth aspect, an embodiment of the present disclosure provides a communication apparatus, where the communication apparatus includes a processor and a memory, where the memory stores a computer program; and the processor executes the computer program stored in the memory to cause the communication apparatus to perform the method for receiving information of the second aspect described above.

In a ninth aspect, an embodiment of the present disclosure provides a communication apparatus, where the apparatus includes a processor and an interface circuit, where the interface circuit is used to receive code instructions and transmit them to the processor, and the processor is used to run the code instructions to cause the apparatus to perform the method for sending information of the first aspect described above.

In a tenth aspect, an embodiment of the present disclosure provides a communication apparatus, where the apparatus includes a processor and an interface circuit, where the interface circuit is used to receive code instructions and transmit them to the processor, and the processor is used to run the code instructions to cause the apparatus to perform the method for receiving information of the second aspect described above.

In an eleventh aspect, an embodiment of the present disclosure provides a communication device, including: one or more processors; where the one or more processors are used to invoke instructions to cause the communication device to perform the method for sending information and the method for receiving information described above.

In a twelfth aspect, an embodiment of the present disclosure provides a communication system, where the system includes the communication apparatus of the third aspect, the communication apparatus of the fourth aspect, or the system includes the communication apparatus of the fifth aspect, the communication apparatus of the sixth aspect, or the system includes the communication apparatus of the seventh aspect, the communication apparatus of the eighth aspect, or the system includes the communication apparatus of the ninth aspect, the communication apparatus of the tenth aspect.

In a thirteenth aspect, an embodiment of the present disclosure provides a computer-readable storage medium, used to store instructions for the first terminal and the second terminal described above, where when the instructions are executed, the first terminal is caused to perform the method for sending information described above, and the second terminal is caused to perform the method for receiving information described above.

In a fourteenth aspect, the present disclosure further provides a computer program product including a computer program, where when run on a computer, the computer program causes the computer to perform the information sending and method for receiving information described above.

In a fifteenth aspect, the present disclosure provides a chip system, where the chip system includes at least one processor and an interface, used to support a first terminal in implementing functions involved in the first aspect, for example, determining or processing at least one of data and information involved in the method described above.

In a possible design, the chip system further includes a memory, where the memory is used to store necessary computer programs and data for the first terminal. The chip system may be composed of a chip, or may include a chip and other discrete devices.

In a sixteenth aspect, the present disclosure provides a chip system, where the chip system includes at least one processor and an interface, used to support a second terminal in implementing functions involved in the second aspect, for example, determining or processing at least one of data and information involved in the method described above.

In a possible design, the chip system further includes a memory, where the memory is used to store necessary computer programs and data for the second terminal. The chip system may be composed of a chip, or may include a chip and other discrete devices.

In a seventeenth aspect, the present disclosure provides a computer program, where when run on a computer, the computer program causes the computer to perform the information sending and method for receiving information described above.

In summary, in the method for sending information, method for receiving information, apparatus, device, chip system, storage medium, computer program, and computer program product provided by the embodiments of the present disclosure, the following technical effects can be achieved:

The first terminal sends additional information to the second terminal in a unicast manner in response to determining that the first condition is met, which can support effective sending of additional information.

### BRIEF DESCRIPTION OF THE DRAWINGS

To describe the technical solutions in the embodiments of the present disclosure or the background technology more clearly, the following briefly describes the accompanying drawings required for describing the embodiments of the present disclosure or the background technology.

FIG. 1 is a schematic architectural diagram of a communication system according to an embodiment of the present disclosure;

FIG. 2 is a schematic flowchart of a method for sending information according to an embodiment of the present disclosure;

FIG. 3 is a schematic flowchart of a method for sending information according to an embodiment of the present disclosure;

FIG. 4 is a schematic flowchart of a method for sending information according to an embodiment of the present disclosure;

FIG. 5 is a schematic flowchart of another method for sending information according to an embodiment of the present disclosure;

FIG. 6 is a schematic flowchart of a method for receiving information according to an embodiment of the present disclosure;

FIG. 7 is a schematic flowchart of another method for receiving information according to an embodiment of the present disclosure;

FIG. 8 is a schematic flowchart of an information interaction method according to an embodiment of the present disclosure;

FIG. 9 is a schematic flowchart of another information interaction method according to an embodiment of the present disclosure;

FIG. 10 is a schematic flowchart of another information interaction method according to an embodiment of the present disclosure;

FIG. 11 is a schematic structural diagram of a communication apparatus according to an embodiment of the present disclosure;

FIG. 12 is a schematic structural diagram of another communication apparatus according to an embodiment of the present disclosure; and

FIG. 13 is a schematic structural diagram of a chip according to an embodiment of the present disclosure.

### DETAILED DESCRIPTION

Hereinafter, exemplary embodiments will be described in detail, and examples thereof are illustrated in the accompanying drawings. When the following description refers to the accompanying drawings, unless otherwise indicated, the same numbers in different drawings represent the same or similar elements. The implementations described in the following exemplary embodiments do not represent all implementations consistent with the embodiments of the present disclosure. On the contrary, they are merely examples of apparatuses and methods consistent with some aspects of the embodiments of the present disclosure as detailed in the appended claims.

The terms used in the embodiments of the present disclosure are for the purpose of describing particular embodiments only and are not intended to limit the embodiments of the present disclosure. The singular forms “a”, “an”, and “the” used in the embodiments of the present disclosure and the appended claims are also intended to include plural forms, unless the context clearly indicates otherwise. It should also be understood that the term “and/or” as used herein refers to and includes any and all possible combinations of one or more of the associated listed items.

It should be understood that although terms such as first, second, third, etc. may be used in the embodiments of the present disclosure to describe various information, such information should not be limited to these terms. These terms are only used to distinguish information of the same type from one another. For example, without departing from the scope of the embodiments of the present disclosure, first information may also be referred to as second information, and similarly, second information may also be referred to as first information. Depending on the context, the word “if” or “if”′ as used herein may be interpreted as “when” or “upon” or “in response to determining”.

For ease of understanding, the terms involved in the present disclosure are first introduced.
1. ProSe-enabled Public Safety UE: a user equipment (UE) where a home public land mobile network (HPLMN) has been configured and authorized for public safety use, ProSe is enabled, and ProSe procedures and functions specific to public safety are supported.
2. ProSe UE-to-Network Relay: a terminal that can provide functions to support a remote terminal in connecting to a network.
3. Relay Service Code (RSC): used to identify a connection service provided by a ProSe UE-to-network relay, and authorized users to whom the ProSe UE-to-network relay will provide services, and may select relevant security policies or information, for example, information necessary for authentication and authorization between a remote UE and the ProSe UE-to-network relay.
4. Remote UE: refers to a remote terminal, which is a terminal supporting ProSe. In 4G, the remote terminal can establish a connection with a 4G network via a ProSe user equipment-to-network relay and communicate with a public data network (PDN). In 5G, the remote terminal can establish a connection with a 5G network via a ProSe user equipment-to-network relay and communicate with a data network (DN).
5. Indirect Network Communication: refers to a network communication mode, for example, where there is a user equipment-to-network relay between a UE and a fifth generation mobile communication technology (5G) network.
6. 5G ProSe UE-to-Network Relay: a terminal that can provide functions to support a remote terminal in connecting to a network.

In the embodiments of the present disclosure, in one mode (for example, Mode A), a ProSe user equipment-to-network relay terminal can broadcast its own terminal information for use by other terminals, and a remote terminal detects relevant messages to achieve discovery of the ProSe user equipment-to-network relay terminal. In another mode (for example, Mode B), the remote terminal can initiate a discovery request for the ProSe user equipment-to-network relay terminal based on a request to send information of another terminal from which a response is expected, that is, information of the requested ProSe user equipment-to-network relay terminal, and a qualified ProSe user equipment-to-network relay terminal responds to the corresponding request. The above Mode A may also be referred to as a first mode, and Mode B may also be referred to as a second mode. That is, the first mode is a mode of broadcasting information of a local terminal for use by other terminals, and the second mode is a mode of sending, in response to a request, information of a terminal from which a response is expected. The description of the first mode and the second mode in the following embodiments may be referred to in this paragraph.

In related art, additional information is sent based on Mode A. If a remote terminal only supports Mode B (in Mode B, a terminal can send, based on a request, information of another terminal from which a response is expected), the additional information cannot be effectively obtained. If the remote terminal only supports Mode A but does not request additional information, unnecessary indication consumption may be caused, and effective sending of additional information cannot be supported.

The embodiments of the present disclosure are provided to solve the technical problem in the related art that effective sending of additional information cannot be supported for cases where Mode A is not used. An method for sending information is provided, where by sending additional information to a second terminal in a unicast manner in response to determining that a first condition is met, effective sending of additional information can be supported.

To better understand the method for sending information disclosed in the embodiments of the present disclosure, a communication system to which the embodiments of the present disclosure are applicable is first described.

Please refer to FIG. 1, which is a schematic architectural diagram of a communication system according to an embodiment of the present disclosure. The communication system may include, but is not limited to, one network device and two terminals. The number and forms of devices shown in FIG. 1 are only for example and do not constitute a limitation on the embodiments of the present disclosure. In practical applications, two or more network devices and two or more terminals may be included. The communication system shown in FIG. 1 includes one network device 11 and two terminals 12 and 13 as an example, where terminal 12 may provide a relay function for terminal 13. An optional example of terminal 12 may be a ProSe UE-to-Network Relay, and an optional example of terminal 13 may be a remote terminal.

In the present disclosure, terminal 12 may be a sending end, and terminal 13 may be a peer terminal, where terminal 13 may be one or more, which is not limited in the present disclosure. Alternatively, terminal 13 may be a sending end, and terminal 12 may be a peer terminal, where terminal 12 may be one or more, which is not limited in the present disclosure.

It should be noted that the technical solutions of the embodiments of the present disclosure may be applied to various communication systems. For example, a long term evolution (LTE) system, a fifth generation (5G) mobile communication system, a 5G new radio (NR) system, or other future new mobile communication systems, etc.

The network device 11 in the embodiments of the present disclosure is an entity on the network side for transmitting or receiving signals. The network device 11 may be a core network device or an access network device. The core network device may be, for example, a location management function (LMF) network element, an access and mobility management function (AMF) network element, a policy control function (PCF) network element, etc. The access network device may be, for example, an evolved NodeB (eNB), a transmission reception point (TRP), a next generation NodeB (gNB) in an NR system, a base station in other future mobile communication systems, or an access node in a wireless fidelity (WiFi) system, etc. The embodiments of the present disclosure do not limit the specific technology and device form adopted by the network device.

The terminal in the embodiments of the present disclosure is an entity on the user side for receiving or transmitting signals, such as a mobile phone. The terminal may also be referred to as a terminal, user equipment (UE), mobile station (MS), mobile terminal (MT), etc. The terminal may be a car with communication functions, a smart car, a vehicle-mounted device, a mobile phone, a wearable device, a tablet computer (Pad), a computer with wireless transceiving functions, a virtual reality (VR) terminal, an augmented reality (AR) terminal, a wireless terminal in industrial control, a wireless terminal in self-driving, a wireless terminal in remote medical surgery, a wireless terminal in a smart grid, a wireless terminal in transportation safety, a wireless terminal in a smart city, a wireless terminal in a smart home, etc. The embodiments of the present disclosure do not limit the specific technology and device form adopted by the terminal.

It can be understood that the communication system described in the embodiments of the present disclosure is to more clearly illustrate the technical solutions of the embodiments of the present disclosure and does not constitute a limitation on the technical solutions provided by the embodiments of the present disclosure. Those of ordinary skill in the art may know that with the evolution of system architectures and the emergence of new business scenarios, the technical solutions provided by the embodiments of the present disclosure are also applicable to similar technical problems.

In the embodiments of the present disclosure, the additional information may be, for example, additional information, and the additional information may also be referred to as additional parameters, which is not limited herein.

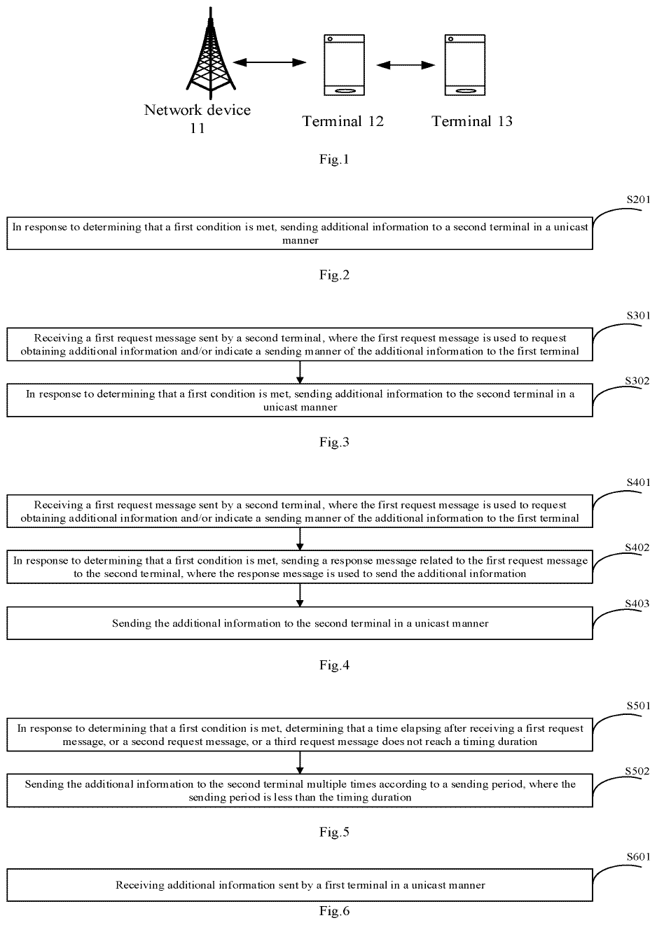

The method for sending information and apparatus provided by the present disclosure are described in detail below with reference to the accompanying drawings. FIG. 2 is a schematic flowchart of a method for sending information according to an embodiment of the present disclosure, where the method is performed by a first terminal. The method for sending information in this embodiment may be applied in a first terminal, where the first terminal may be, for example, a ProSe user equipment-to-network relay, such as a mobile phone, a tablet with mobile communication functions, a smart watch, a smart car, a vehicle-mounted device, etc., which is not limited herein.

As shown in FIG. 2, the method may include, but is not limited to, the following steps:
S201: In response to determining that a first condition is met, sending additional information to a second terminal in a unicast manner.

In some embodiments, the first condition may be, for example, a trigger condition or a threshold condition for triggering sending additional information to the second terminal in a unicast manner. The first condition may be a trigger condition for triggering sending additional information to the second terminal in a unicast manner. For example, when the first terminal determines that the first condition is met, it may trigger sending additional information to the second terminal in a unicast manner, which is not limited herein.

In some embodiments, the first condition may be a preset condition, for example, set based on a system protocol, or may be any other possible form of condition, which is not limited herein.

In some embodiments, the second terminal may be, for example, a remote terminal, Remote UE, which is not limited herein.

In some embodiments, the first terminal may periodically send additional information to the second terminal, which is not limited herein.

The method for sending information in the embodiments of the present disclosure may support Mode A and Mode B. That is, there is no restriction on the mode type supported by the first terminal and/or the second terminal (for example, Mode A or Mode B).

In some embodiments, the first terminal may periodically send additional information, or the first terminal may send additional information when new or updated additional information is detected, or when new or updated additional information is generated but cannot be sent to the second terminal, the first terminal may send additional information to the second terminal, which is not limited herein.

In some embodiments, a relay terminal (an optional example of the first terminal) sends additional information or updated additional information to a remote terminal (an optional example of the second terminal) in a unicast manner, which is not limited herein.

In some embodiments, the unicast manner may be referred to as a unicast transmission manner. Unicast transmission refers to establishing a point-to-point network connection between a sender and each receiver. Optional examples include a response to an additional information request, a new request, or a discovery response in Mode B, which is not limited herein.

In some embodiments, the first terminal may detect whether the first condition is met. If the first condition is met, it may send additional information to the second terminal in a unicast manner.

Thus, since the first terminal detects whether the first condition is met and sends additional information to the second terminal in a unicast manner in response to determining that the first condition is met, and since both Mode A and Mode B can be supported, and on-demand sending is achieved through the unicast manner to save transmission consumption, and sending additional information is triggered when the first condition is met, the timeliness of sending additional information can be improved, and effective sending of additional information can be supported.

In the method for sending information provided by the embodiments of the present disclosure, the additional information includes at least one of a temporary mobile group identity (TMGI), a cell global identifier (CGI), or a tracking area identity (TAI), to improve the comprehensiveness of additional information coverage.

In the method for sending information provided by the embodiments of the present disclosure, the additional information may further include at least one of a temporary mobile group identity (TMGI), an E-UTRAN cell global identifier (ECGI), a new radio cell global identifier (NCGI), or a TAI, to improve the comprehensiveness of additional information coverage.

Of course, the additional information may also include any other possible information that can be used to assist proximity service communication, which is not limited herein.

In some embodiments, in a long term evolution (LTE) network, the access network part is referred to as an evolved universal mobile telecommunications system (UMTS) terrestrial radio access network (E-UTRAN), that is, the mobile communication wireless network in LTE, which is not limited herein.

In the method for sending information provided by the embodiments of the present disclosure, determining that the first condition is met may include at least one of: obtaining additional information; obtaining updated additional information; a first mode being not configured, where the first mode is a mode of broadcasting information of a local terminal for use by other terminals; receiving a first request message sent by the second terminal, where the first request message is used to request obtaining additional information and/or indicate a sending manner of the additional information to the first terminal; receiving a second request message sent by the second terminal, where the second request message is used to request sending the additional information to the second terminal in the unicast manner; or receiving a third request message sent by a third terminal, where the third request message is at least used to instruct sending the additional information to the second terminal. Thus, on-demand sending can be achieved, and the timeliness and accuracy of sending additional information can be improved.

In some embodiments, when the first terminal obtains additional information or updated additional information, it may trigger sending the additional information or updated additional information to the second terminal. Obtaining additional information or updated additional information may be, for example, the first terminal detecting new additional information or updated additional information, which is not limited herein.

In some embodiments, the first terminal may interact with the network to detect additional information or updated additional information, which is not limited herein.

In some embodiments, a 5G ProSe UE-to-Network Relay detects new parameter(s), where the 5G ProSe UE-to-Network Relay is an optional example of the first terminal, and the 5G ProSe UE-to-Network Relay may detect one or more new parameters (an optional example of additional information), which is not limited herein.

In some embodiments, when the first terminal obtains new additional information and/or updated additional information, it may send the additional information (for example, new additional information and/or updated additional information) to the second terminal in a unicast manner, which is not limited herein.

In some embodiments, the first terminal may send new additional information and/or updated additional information to the second terminal in a unicast manner at least once, which is not limited herein.

In some embodiments, when the first terminal detects that the duration after the last sending of new additional information or updated additional information reaches a sending period, it may trigger sending new additional information or updated additional information to the second terminal, which is not limited herein.

In some embodiments, the sending period may be preconfigured. The sending period may be determined based on a configurable sending frequency. For example, a frequency may be preconfigured, and the sending period may be determined based on the configured frequency, which is not limited herein.

In some embodiments, when the first terminal determines that the first mode is not configured, it may send additional information to the second terminal in a unicast manner, where the first mode is a mode of broadcasting information of a local terminal for use by other terminals. The first mode may be, for example, Mode A. In the first mode, a terminal may broadcast its own terminal information for use by other terminals, which is not limited herein.

In some embodiments, after receiving a first request message sent by the second terminal, the first terminal may send additional information to the second terminal in a unicast manner, where the first request message is used to request obtaining additional information and/or indicate a sending manner of the additional information to the first terminal, which is not limited herein.

The first request message may be, for example, an Additional Parameters Announcement Request. The Additional Parameters Announcement Request may be used to request obtaining additional parameters. The additional parameters may also be referred to as additional information, which is not limited herein.

In some embodiments, after receiving a second request message sent by the second terminal, the first terminal may send additional information to the second terminal in a unicast manner, where the second request message is used to request sending the additional information to the second terminal in the unicast manner, thereby achieving sending additional information to the second terminal in the unicast manner in response to the request, which is not limited herein.

The second request message may be a new request message used to request sending the additional information to the second terminal in the unicast manner. The second request message may be, for example, an Additional Parameters Request, which is not limited herein.

In some embodiments, after receiving a third request message sent by a third terminal, the first terminal may send additional information to the second terminal in a unicast manner, where the third request message is at least used to instruct sending the additional information to the second terminal, which is not limited herein.

The third terminal may be, for example, another remote terminal. That is, the number of remote terminals may be one or more. The first terminal may send additional information to at least one of the remote terminals, which may be triggered by another remote terminal to send additional information to one remote terminal, which is not limited herein.

In some embodiments, a message sent by another remote terminal to instruct sending additional information to the second terminal may be referred to as the third request message, which is not limited herein.

In some embodiments, the third terminal may also be, for example, another Remote UE, and the second terminal may also be, for example, a Remote UE, an initiating UE (a UE that initiates an additional information request), which is not limited herein.

In some embodiments, the third request message may further include a sending manner of the additional information. In one sending manner, sending additional information to all remote terminals in a unicast manner is supported. If the first terminal receives the third request message and determines that the third request message instructs sending additional information to all remote terminals, it may send additional information to at least the second terminal in a unicast manner, which is not limited herein.

FIG. 3 is a schematic flowchart of a method for sending information according to an embodiment of the present disclosure, where the method is performed by a first terminal. The method for sending information in this embodiment may be applied in a first terminal, where the first terminal may be, for example, a ProSe user equipment-to-network relay, which is not limited herein.

As shown in FIG. 3, the method may include, but is not limited to, the following steps:
S301: Receiving a first request message sent by a second terminal, where the first request message is used to request obtaining additional information and/or indicate a sending manner of the additional information to the first terminal.

In some embodiments, the first terminal may, in response to the request, send additional information to the second terminal in a unicast manner. For example, the first terminal, in response to the first request message sent by the second terminal, sends additional information to the second terminal in a unicast manner, thereby achieving on-demand sending of additional information through the unicast manner to save transmission consumption.

The first request message may be, for example, an Additional Parameters Announcement Request. The Additional Parameters Announcement Request may be used to request obtaining additional parameters. The additional parameters may also be referred to as additional information, which is not limited herein.

In some embodiments, the first request message may be used to request obtaining additional information, or may be used to indicate a subsequent sending manner of the additional information to the first terminal, or may be used to request obtaining additional information and indicate a subsequent sending manner of the additional information to the first terminal, which is not limited herein.

In some embodiments, the sending manner refers to the manner in which the first terminal subsequently sends additional information to other remote terminals. The sending manner may be indicated by one of the remote terminals. The sending manner may also be referred to as a provisioning method, which is not limited herein.
S302: In response to determining that a first condition is met, sending additional information to the second terminal in a unicast manner.

In some embodiments, the first terminal may determine whether the first condition is met based on the trigger of the first request message sent by the second terminal, and in response to determining that the first condition is met, send additional information to the second terminal in a unicast manner, which is not limited herein.

Thus, in this embodiment, by receiving the first request message sent by the second terminal, where the first request message is used to request obtaining additional information and/or indicate a sending manner of the additional information to the first terminal, and in response to determining that the first condition is met, sending additional information to the second terminal in a unicast manner, on-demand sending through the unicast manner is achieved to save transmission consumption, thereby effectively improving the effect of sending additional information.

In the method for sending information provided by the embodiments of the present disclosure, the first terminal may further receive a third request message sent by a third terminal, where the third request message is used to instruct sending the additional information to the second terminal, request obtaining the additional information, and indicate a sending manner of the additional information to the first terminal, to support timely sending of additional information to the second terminal.

The third request message may be, for example, an Additional Parameters Announcement Request sent by the third terminal to the first terminal. The Additional Parameters Announcement Request may be used to request obtaining additional parameters, indicate a sending manner of the additional information to the first terminal, and instruct sending the additional information to the second terminal. The additional parameters may also be referred to as additional information, which is not limited herein.

In the method for sending information provided by the embodiments of the present disclosure, the sending manner may include at least one of: sending the additional information to the second terminal in the unicast manner; sending the additional information to all terminals using a same relay service code (RSC) based on a discovery procedure of a first mode, where the first mode is a mode of broadcasting information of a local terminal for use by other terminals; sending the additional information to all terminals using a same RSC based on a discovery procedure of a second mode, where the second mode is a mode of sending, in response to a request, information of a terminal from which a response is expected; or sending the additional information to all terminals using a same RSC based on discovery procedures of a first mode and a second mode. This can significantly improve the flexibility of sending additional information and effectively adapt to personalized communication scenario requirements.

In some embodiments, sending the additional information to the second terminal in the unicast manner may be, for example, provisioning the additional parameters to the initiating UE with unicast only, where the initiating UE (a UE that initiates an additional information request) is an optional example of the second terminal, which is not limited herein.

In some embodiments, sending the additional information to all terminals using a same RSC based on a discovery procedure of a first mode may be, for example, provisioning the additional parameters to all the UEs using the same RSC with Mode A discovery procedure only, where Mode A is an optional example of the first mode, which is not limited herein.

In some embodiments, it may also be sending the additional information to all terminals using a same RSC based on a discovery procedure of a second mode, where the second mode is a mode of sending, in response to a request, information of a terminal from which a response is expected, which is not limited herein.

In some embodiments, sending the additional information to all terminals using a same RSC based on discovery procedures of a first mode and a second mode may be, for example, provisioning the additional parameters to all the UEs using the same RSC with Mode A and Mode B procedures triggered, which is not limited herein.

FIG. 4 is a schematic flowchart of a method for sending information according to an embodiment of the present disclosure, where the method is performed by a first terminal. The method for sending information in this embodiment may be applied in a first terminal, where the first terminal may be, for example, a ProSe user equipment-to-network relay, which is not limited herein.

As shown in FIG. 4, the method may include, but is not limited to, the following steps:
S401: Receiving a first request message sent by a second terminal, where the first request message is used to request obtaining additional information and/or indicate a sending manner of the additional information to the first terminal.
S402: In response to determining that a first condition is met, sending a response message related to the first request message to the second terminal, where the response message is used to send the additional information.

In some embodiments, when the first terminal receives the first request message sent by the second terminal, it may, in response to determining that the first condition is met, send a response message related to the first request message to the second terminal in response to the first request message, which is not limited herein.

In some embodiments, the response message may be used to indicate the additional information, which is not limited herein.

In some embodiments, the response message may also be used to indicate a timing duration. The description of the timing duration may be referred to in subsequent embodiments. Alternatively, the response message may be used to indicate the timing duration and the additional information, which is not limited herein.

In some embodiments, the response message may include or carry the additional information, which is not limited herein.

In some embodiments, the first terminal may decide whether to include the additional information in the response message, or the first terminal may determine whether to include the additional information in the response message based on an indication from the second terminal, which is not limited herein.
S403: Sending the additional information to the second terminal in a unicast manner.

It should be noted that in this embodiment of the present disclosure, steps S402 and S403 may be performed separately or together, which is not limited in the embodiments of the present disclosure.

Thus, in this embodiment, on-demand sending through the unicast manner is achieved to save transmission consumption, thereby effectively improving the effect of sending additional information. Moreover, the first terminal can promptly feed back a response message to the second terminal, and send the additional information through the response message, which can also effectively improve the comprehensiveness of indication.

In the method for sending information provided by the present disclosure, the first terminal may further indicate a timing duration to the second terminal. When the timing duration has not expired, the additional information may be sent to the second terminal multiple times.

In the method for sending information provided by the present disclosure, the first terminal may further receive a second request message sent by the second terminal, where the second request message is used to request sending the additional information to the second terminal in the unicast manner, thereby effectively improving the effectiveness and flexibility of additional information indication.

The second request message may be a new request message used to request sending the additional information to the second terminal in the unicast manner. The second request message may be, for example, an Additional Parameters Request, which is not limited herein.

Optionally, the request may include a provisioning method, used to indicate a sending manner of the additional parameters, for example, sending only to the initiating terminal of the additional parameters request, or sending to the initiating terminal of the additional parameters request and other terminals, which is not limited herein.

In the method for sending information provided by the present disclosure, the first terminal may further send a new message to the second terminal, where the new message is used to send the additional information, thereby saving transmission consumption and improving the effect of sending additional information.

FIG. 5 is a schematic flowchart of another method for sending information according to an embodiment of the present disclosure, where the method is performed by a first terminal. The method for sending information in this embodiment may be applied in a first terminal, where the first terminal may be, for example, a ProSe user equipment-to-network relay, which is not limited herein.

As shown in FIG. 5, the method may include, but is not limited to, the following steps:
S501: In response to determining that a first condition is met, determining that a time elapsing after receiving a first request message, or a second request message, or a third request message does not reach a timing duration.

The explanation and reception manner of the first request message, the second request message, or the third request message may be specifically referred to in the above embodiments, and are not repeated here.

In some embodiments, when the time elapsing after receiving the first request message, the second request message, or the third request message does not reach the timing duration, additional information may be sent to the second terminal, which is not limited herein.
S502: Sending the additional information to the second terminal multiple times according to a sending period, where the sending period is less than the timing duration.

In some embodiments, when the time elapsing after receiving the first request message, the second request message, or the third request message does not reach the timing duration, the first terminal may, in response to determining that the first condition is met, send additional information to the second terminal multiple times in a unicast manner, or in response to determining that a second condition is met, send additional information to the second terminal multiple times in a broadcast manner, where the sending period is less than the timing duration. The timing duration is used for timing the re-request of the first request message, the second request message, or the third request message, and also for timing the sending of additional information from the first terminal to the second terminal, which is not limited herein.

For example, the timing duration may be, for example, the timing duration of an Additional_Parameters_Announcement_Request_Refresh timer. The timing duration is used for timing the re-sending of an Additional Parameters Announcement Request. The timing duration may be configured by a 5G ProSe UE-to-Network Relay, which is not limited herein.

In some embodiments, the Additional_Parameters_Announcement_Request_Refresh timer may be, for example, an Additional_Parameters_Announcement_Request_Refresh Timer, which is not limited herein.

For example, the timing duration may also be the timing duration of an Additional Parameters Refresh timer. The timing duration is used for timing the re-sending of an Additional Parameters Request. The timing duration may be configured by a 5G ProSe UE-to-Network Relay, which is not limited herein.

In some embodiments, the Additional_Parameters_Refresh timer may be, for example, an Additional_Parameters_Refresh Timer, which is not limited herein.

In some embodiments, when the first terminal determines that the time elapsing after receiving the second request message sent by the second terminal does not reach the timing duration, it may send additional information to the second terminal, which is not limited herein.

In some embodiments, the sending period being less than the timing duration can effectively improve the timeliness and effectiveness of sending additional information.

In some embodiments, the sending period being less than the timing duration may mean providing the additional parameters at a configurable frequency normally higher than the one related to the Additional_Parameters_Announcement_Request_Refresh Timer. That is, the configurable sending frequency (the reciprocal of the configurable sending frequency is the sending period) is generally higher than the frequency related to the Additional_Parameters_Announcement_Request_Refresh Timer, which is not limited herein.

In some embodiments, the sending period being less than the timing duration may mean providing the additional parameters at a configurable frequency normally higher than the one related to the Additional_Parameters_Refresh Timer. That is, the configurable sending frequency (the reciprocal of the configurable sending frequency is the sending period) is normally higher than the frequency related to the Additional_Parameters Refresh Timer, which is not limited herein.

In the method for sending information provided by the present disclosure, the first terminal may further, in response to determining that a second condition is met, send the additional information in a broadcast manner, thereby improving the flexibility and applicability of additional information indication.

In some embodiments, the second condition may be, for example, a trigger condition or a threshold condition for triggering sending the additional information in a broadcast manner. The second condition may also be, for example, a trigger condition for triggering sending the additional information in a broadcast manner. For example, when the first terminal determines that the second condition is met, it may trigger sending the additional information in a broadcast manner, which is not limited herein.

In some embodiments, the second condition may be a preset condition, for example, set based on a system protocol, or may be any other possible form of condition, which is not limited herein.

In some embodiments, the second condition may be a trigger condition for triggering sending the additional information in a broadcast manner. For example, when any terminal instructs the first terminal to send the additional information in a broadcast manner, the first terminal may determine that the second condition is met, which is not limited herein.

In the method for sending information provided by the present disclosure, determining that the second condition is met includes: determining to send the additional information in the broadcast manner based on a sending manner of the additional information indicated by a terminal, where the terminal is the second terminal or another terminal; and/or a first mode is not configured, which is not limited herein.

In some embodiments, if it is determined to send the additional information in the broadcast manner based on the sending manner of the additional information indicated by a terminal, the additional information may be sent in the broadcast manner. For example, the additional information may be broadcast to the second terminal, or to other terminals. The other terminals may be, for example, other remote terminals, which is not limited herein.

In some embodiments, if the first terminal is not configured with the first mode, it may send the additional information in the broadcast manner. For example, the additional information may be broadcast to the second terminal, or to other terminals. The other terminals may be, for example, other remote terminals, which is not limited herein.

It should be noted that in the following embodiments, descriptions of methods that are the same as or correspond to those in the above embodiments may be referred to in the above embodiments and are not repeated here.

FIG. 6 is a schematic flowchart of a method for receiving information according to an embodiment of the present disclosure, where the method is performed by a second terminal. The method for receiving information in this embodiment may be applied in a terminal, where the second terminal may be, for example, a remote terminal, Remote UE, initiating UE (a UE that initiates an additional information request), which is not limited herein.

As shown in FIG. 6, the method may include, but is not limited to, the following steps:
S601: Receiving additional information sent by a first terminal in a unicast manner.

In some embodiments, the first terminal, in response to determining that a first condition is met, sends additional information to the second terminal in a unicast manner, and the second terminal may receive the additional information sent by the first terminal in the unicast manner.

In this embodiment, by receiving the additional information sent by the first terminal in the unicast manner, effective reception of additional information can be supported.

In the method for sending information provided by the embodiments of the present disclosure, the additional information includes at least one of a temporary mobile group identity (TMGI), a cell global identifier (CGI), or a tracking area identity (TAI), to improve the comprehensiveness of additional information coverage.

In the method for sending information provided by the embodiments of the present disclosure, the additional information may further include at least one of a temporary mobile group identity (TMGI), an E-UTRAN cell global identifier (ECGI), a new radio cell global identifier (NCGI), or a TAI, to improve the comprehensiveness of additional information coverage.

Of course, the additional information may also include any other possible information that can be used to assist proximity service communication, which is not limited herein.

In some embodiments, in a long term evolution (LTE) network, the access network part is referred to as an evolved universal mobile telecommunications system (UMTS) terrestrial radio access network (E-UTRAN), that is, the mobile communication wireless network in LTE, which is not limited herein.

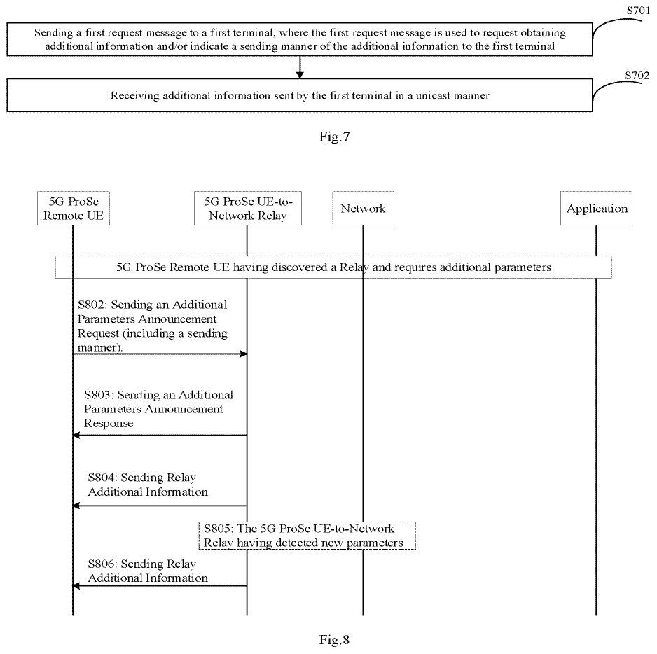

FIG. 7 is a schematic flowchart of another method for receiving information according to an embodiment of the present disclosure, where the method is performed by a second terminal. The method for receiving information in this embodiment may be applied in a second terminal, where the second terminal may be, for example, a remote terminal, Remote UE, initiating UE (a UE that initiates an additional information request), which is not limited herein.

As shown in FIG. 7, the method may include, but is not limited to, the following steps:
S701: Sending a first request message to a first terminal, where the first request message is used to request obtaining additional information and/or indicate a sending manner of the additional information to the first terminal.
S702: Receiving additional information sent by the first terminal in a unicast manner.

In this embodiment, by sending the first request message to the first terminal, where the first request message is used to request obtaining additional information and/or indicate a sending manner of the additional information to the first terminal, and receiving the additional information sent by the first terminal in the unicast manner, on-demand sending through the unicast manner is achieved to save transmission consumption, effectively improving the effect of sending additional information.

In the method for sending information provided by the embodiments of the present disclosure, the second terminal may receive a response message related to the first request message sent by the first terminal, where the response message is used to send the additional information.

The description of this embodiment may be specifically referred to in the above embodiments and is not repeated here.

In the method for sending information provided by the embodiments of the present disclosure, the second terminal may receive a new message sent by the first terminal, where the new message is used to send the additional information.

The description of this embodiment may be specifically referred to in the above embodiments and is not repeated here.

In the method for sending information provided by the embodiments of the present disclosure, the second terminal may receive a timing duration indicated by the first terminal.

The description of this embodiment may be specifically referred to in the above embodiments and is not repeated here.

In the method for sending information provided by the embodiments of the present disclosure, the second terminal may receive the additional information sent multiple times by the first terminal according to a sending period, where the sending period is less than a timing duration.

In the method for sending information provided by the embodiments of the present disclosure, the second terminal may send a second request message to the first terminal, where the second request message is used to request sending the additional information to the second terminal in the unicast manner.

The description of this embodiment may be specifically referred to in the above embodiments and is not repeated here.

In the method for sending information provided by the embodiments of the present disclosure, the second terminal may receive the additional information sent by the first terminal in a broadcast manner.

The description of this embodiment may be specifically referred to in the above embodiments and is not repeated here.

FIG. 8 is a schematic flowchart of an information interaction method according to an embodiment of the present disclosure, which shows an interaction diagram among a first terminal, a second terminal, and a network. In this embodiment, the first terminal may be, for example, a 5G ProSe UE-to-Network Relay, and the second terminal may be, for example, a 5G ProSe Remote UE, which is not limited herein.

In this embodiment, an additional parameters request reuses an additional parameters announcement procedure. It is assumed that a 5G ProSe Remote UE has discovered a 5G ProSe UE-to-Network Relay, the 5G ProSe Remote UE may add parameters (the added parameters may be referred to as additional parameters, and the additional parameters may also be additional information) according to application requirements, and the 5G ProSe Remote UE and/or the 5G ProSe UE-to-Network Relay are not configured with Mode A, which is not limited herein.

As shown in FIG. 8, the method may include, but is not limited to, the following steps:
S801: A 5G ProSe Remote UE having discovered a Relay and requires additional parameters.

In some embodiments, the 5G ProSe Remote UE has discovered a Relay and requires additional parameters, which is not limited herein.
S802: Sending an Additional Parameters Announcement Request (including a sending manner).

In some embodiments, the Additional Parameters Announcement Request may be, for example, an Additional Parameters Announcement Request, and the sending manner may be, for example, a Provisioning method, which is not limited herein.

In some embodiments, the 5G ProSe Remote UE may send an Additional Parameters Announcement Request to the 5G ProSe UE-to-Network Relay, which is not limited herein.

In some embodiments, the 5G ProSe Remote UE may send an Additional Parameters Announcement Request to the 5G ProSe UE-to-Network Relay to obtain additional parameters. According to local configuration or application requirements, the 5G ProSe Remote UE may indicate a provisioning method of the additional parameters (an optional example of the sending method), for example, using one of the following options:
1. Provisioning the additional parameters to the initiating UE with unicast only.

In some embodiments, the additional information may be sent to the second terminal in a unicast manner, which is not limited herein.
2. Provisioning the additional parameters to all the UEs using the same RSC with Mode A discovery procedure only.

In some embodiments, the additional information is sent to all terminals using a same relay service code (RSC) based on a discovery procedure of a first mode, where the first mode is a mode of broadcasting information of a local terminal for use by other terminals, which is not limited herein.
3. Provisioning the additional parameters to all the UEs using the same RSC with Mode A and Mode B procedures triggered.

In some embodiments, the additional information is sent to all terminals using a same RSC based on discovery procedures of a first mode and a second mode, where the second mode is a mode of sending, in response to a request, information of a terminal from which a response is expected, which is not limited herein.
S803: Sending an Additional Parameters Announcement Response.

In some embodiments, the Additional Parameters Announcement Response may be, for example, an Additional Parameters Announcement Response, which is not limited herein.

The Additional Parameters Announcement Response may include:
An Additional_Parameters_Announcement_Request_Refresh Timer;
Additional parameters (the additional parameters may include various information).

In some embodiments, the Additional Parameters Announcement Response may include:
An Additional_Parameters_Announcement_Request_Refresh timer; and/or additional parameters, which is not limited herein.

In some embodiments, the 5G ProSe UE-to-Network Relay indicates confirmation of receiving the Additional Parameters Announcement Request in step S802 through the Additional Parameters Announcement Response, which is not limited herein.

In some embodiments, if the 5G ProSe UE-to-Network Relay provides an Additional_Parameters_Announcement_Request Refresh Timer to the 5G ProSe Remote UE (which may be configured in the 5G ProSe UE-to-network Relay), it is used as an exit mechanism. When this timer expires, if the 5G ProSe Remote UE still needs to obtain additional parameters, the Additional Parameters Announcement Request procedure is repeated, which is not limited herein.

In some embodiments, if after the Additional Parameters_Announcement_Request_Refresh timer expires, the 5G ProSe Remote UE does not initiate a new Additional Parameters Announcement Request procedure, and before the Additional_Parameters_Announcement_Request_Refresh timer in the 5G ProSe UE-to-Network Relay expires, no other terminal requests an Additional Parameters Announcement, the 5G ProSe UE-to-Network Relay may stop providing additional parameters, which is not limited herein.

In some embodiments, the additional parameters may be included in the Additional Parameters Announcement Response to provide the additional parameters to the 5G ProSe Remote UE, which is not limited herein.

In some embodiments, the 5G ProSe UE-to-Network Relay may make a decision based on the indication received from the 5G ProSe Remote UE in S802 to include the additional parameters in the Additional Parameters Announcement Response. For example, the 5G ProSe Remote UE indicates provisioning the additional parameters to the initiating UE with unicast only, and/or based on local configuration, for example, the 5G ProSe UE-to-Network Relay is not configured with Mode A.
S804: Sending Relay Additional Information.

In some embodiments, sending Relay Additional Information may be, for example, Relay Additional Information provisioning, which is not limited herein.

In some embodiments, the 5G ProSe UE-to-Network Relay may send additional information to the 5G ProSe Remote UE, which is not limited herein.

In some embodiments, the 5G ProSe UE-to-Network Relay provides the additional parameters by sending a Relay Additional Information provisioning message. This message is not used for Mode A discovery but is a unicast communication message sent to the initiating 5G ProSe Remote UE, and is periodically repeated at a configurable sending frequency (the configurable sending frequency is normally higher than the frequency related to the Additional_Parameters_Announcement_Request_Refresh timer) until no Remote UE requests provision of additional parameters (which may be determined by the Additional Parameters_Announcement_Request_Refresh timer running in the 5G ProSe UE-to-Network Relay), which is not limited herein.
S805: The 5G ProSe UE-to-Network Relay having detected new parameters.

In some embodiments, the 5G ProSe UE-to-Network Relay detects new parameter(s), which is not limited herein.

In some embodiments, the 5G ProSe UE-to-Network Relay detects new or updated additional parameters, which is not limited herein.
S806: Sending Relay Additional Information.

In some embodiments, sending Relay Additional Information may be, for example, Relay Additional Information provisioning, which is not limited herein.

In some embodiments, the 5G ProSe UE-to-Network Relay may send additional information to the 5G ProSe Remote UE multiple times, which is not limited herein.

In some embodiments, detecting new or updated additional parameters in S805 triggers the 5G ProSe UE-to-Network Relay to immediately send a Relay Additional Information provisioning message to the 5G ProSe Remote UE that requested provision of additional parameters to provide the additional parameters, and optionally periodically repeat this at the configurable sending frequency in S804 until there is no Remote UE requesting provision of additional parameters, which is not limited herein.

For example, until the Additional_Parameters_Announcement_Request_Refresh Timer in the 5G ProSe UE-to-Network Relay expires, which is not limited herein.

FIG. 9 is a schematic flowchart of another information interaction method according to an embodiment of the present disclosure, which shows an interaction diagram among a first terminal and multiple second terminals. In this embodiment, the first terminal may be, for example, a UE-to-Network Relay, and the second terminals may be, for example, Remote UE-1, Remote UE-2, Remote UE-3, which is not limited herein.

In this embodiment, for the case where both the remote terminal and the relay terminal are configured for Mode A, the relay terminal announcing additional information may retrieve the additional information through Mode A. To distinguish the manner of providing additional parameters, the relay terminal may make a decision based on input from a remote terminal, which is not limited herein.

As shown in FIG. 9, the method may include, but is not limited to, the following steps:
S901: A 5G ProSe Remote UE having discovered a Relay and requires additional parameters.

In some embodiments, the 5G ProSe Remote UE has discovered a Relay and requires additional parameters, which is not limited herein.
S902: Sending an Additional Parameters Announcement Request (including a sending manner).

In some embodiments, the Additional Parameters Announcement Request may be, for example, an Additional Parameters Announcement Request, and the sending manner may be, for example, a Provisioning method, which is not limited herein.

In some embodiments, the 5G ProSe Remote UE may send an Additional Parameters Announcement Request to the 5G ProSe UE-to-Network Relay, which is not limited herein.

In some embodiments, the sending manner Provisioning method included in the request is used to indicate a sending manner of the additional parameters, for example, sending the additional information to all terminals using a same relay service code (RSC) based on a discovery procedure of a first mode.
S903: Sending an Additional Parameters Announcement Response.

In some embodiments, the Additional Parameters Announcement Response may include:
An Additional_Parameters_Announcement_Request_Refresh Timer, that is, an Additional_Parameters_Announcement_Request_Refresh timer, which is not limited herein.

In some embodiments, the Additional Parameters Announcement Response may be, for example, an Additional Parameters Announcement Response, which is not limited herein.

The Additional Parameters Announcement Response may include:
An Additional_Parameters_Announcement_Request_Refresh Timer.
S904a: Additional Information Announcement Decision.

In some embodiments, the Additional Information Announcement Decision may be, for example, an Additional Information Announcement Decision, which is not limited herein.

In some embodiments, the (UE-to-Network Relay) may decide to send an Additional Information Announcement, which is not limited herein.
S904b: UE-to-Network Relay Discovery Additional Information.

In some embodiments, the UE-to-Network Relay Discovery Additional Information may be, for example, UE-to-Network Relay Discovery Additional Information, which is not limited herein.

In some embodiments, the user equipment-to-network relay may discover additional information, which is not limited herein.

In some embodiments, the additional parameters may be included in a Relay Discovery Additional Information message announced by the UE-to-Network Relay triggered by an Additional Parameters Request from one of the remote terminals, which is not limited herein.

In some embodiments, the UE-to-Network Relay may make a decision to use Mode A to announce the additional parameters based on the indication received from the request of the 5G ProSe Remote UE in S902 (for example, the remote UE indicates provisioning the additional parameters to the initiating UE with Mode A) and based on local configuration (for example, the relay is not configured with Mode A), which is not limited herein.

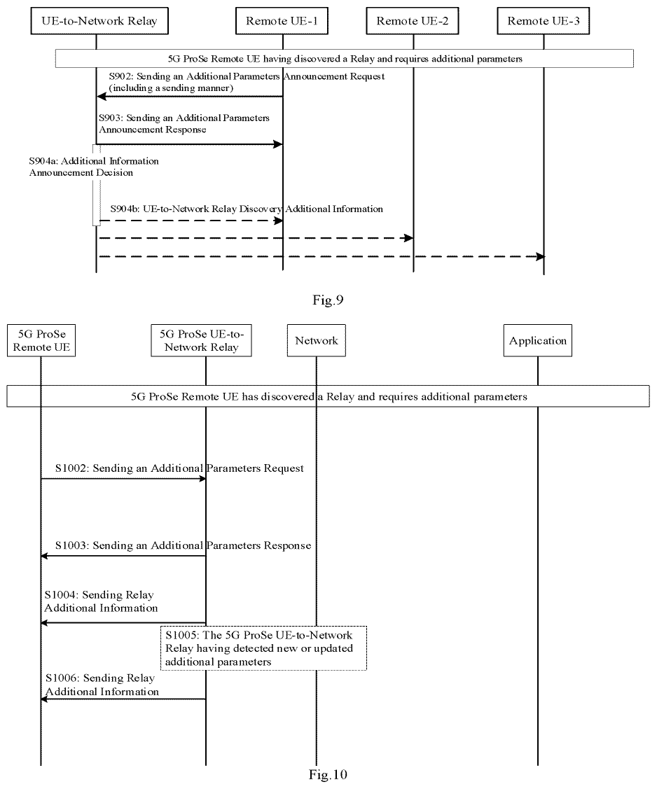

FIG. 10 is a schematic flowchart of another information interaction method according to an embodiment of the present disclosure, which shows an interaction diagram among a first terminal, a second terminal, and a network. In this embodiment, the first terminal may be, for example, a 5G ProSe UE-to-Network Relay, and the second terminal may be, for example, a 5G ProSe Remote UE, which is not limited herein.

In this embodiment, it is assumed that a 5G ProSe Remote UE has discovered a 5G ProSe UE-to-Network Relay and may obtain additional parameters (or additional information) according to an application request, which is not limited herein.

In this embodiment, the 5G ProSe Remote UE may request additional parameters in unicast only through a new procedure, which is not limited herein.

As shown in FIG. 10, the method may include, but is not limited to, the following steps:
S1001: A 5G ProSe Remote UE has discovered a Relay and requires additional parameters.

In some embodiments, the 5G ProSe Remote UE has discovered a Relay and requires additional parameters, which is not limited herein.
S1002: Sending an Additional Parameters Request.

In some embodiments, the Additional Parameters Request may be, for example, an Additional Parameters Request, which is not limited herein.

In some embodiments, the 5G ProSe Remote UE sends an Additional Parameters Request to the 5G ProSe UE-to-Network Relay to obtain additional parameters. Different from the Additional Parameters Announcement Request message in related art, this Additional Parameters Request is only used to request additional parameters in unicast, which is not limited herein.

Optionally, the request may include a sending manner Provisioning method, used to indicate a sending manner of the additional parameters, for example, sending only to the initiating terminal of the additional parameters request, or sending to the initiating terminal of the additional parameters request and other terminals, which is not limited herein.
S1003: Sending an Additional Parameters Response.

In some embodiments, the Additional Parameters Response may be, for example, an Additional Parameters Response, which is not limited herein.

In some embodiments, the Additional Parameters Response may include: an Additional Parameters_Refresh timer and additional parameters may include various information, which is not limited herein.

The Additional Parameters Response may include:
An Additional_Parameters_Refresh Timer;
Additional parameters (the additional parameters may include various information).

In some embodiments, the Additional Parameters Response may be, for example, an Additional Parameters Response, which is not limited herein.

In some embodiments, the Additional Parameters Response may include an Additional Parameters_Refresh timer, and/or additional parameters, which is not limited herein.

In some embodiments, the 5G ProSe UE-to-Network Relay indicates confirmation of receiving the request in S1002 (Additional Parameters Request) through the Additional Parameters Response (which may include an Additional_Parameters Refresh timer, and/or additional parameters), which is not limited herein.

In some embodiments, if an Additional Parameters Refresh timer is provided to the 5G ProSe Remote UE (which may be configured in the 5G ProSe UE-to-network Relay), it is used as follows: when this Additional_Parameters_Refresh timer expires, if the 5G ProSe Remote UE still needs to obtain additional parameters, the Additional Parameters Request procedure may be repeated, which is not limited herein.

In some embodiments, if the Additional_Parameters_Refresh timer expires and the 5G ProSe Remote UE does not initiate a new Additional Parameters Announcement Request procedure, the 5G ProSe UE-to-Network Relay stops providing additional parameters, which is not limited herein.

In some embodiments, the additional parameters may be included in the Additional Parameters Response message to provide the additional parameters to the initiating terminal, which is not limited herein.
S1004: Sending Relay Additional Information.

In some embodiments, sending Relay Additional Information may be, for example, through Relay Additional Information provisioning, which is not limited herein.

In some embodiments, Relay Additional Information provisioning may be, for example, a Relay Additional Information provisioning message, which is not limited herein.

In some embodiments, the 5G ProSe UE-to-Network Relay provides the additional parameters by sending a Relay Additional Information provisioning message. This message may be a unicast communication message sent to the initiating remote UE (for example, the 5G ProSe Remote UE that sent the Additional Parameters Request), and is periodically repeated at a configurable sending frequency (which may be higher than the frequency related to the Additional Parameters_Refresh timer) until the Additional_Parameters_Refresh timer expires, or no Remote UE requests provision of additional parameters, which may be determined by the Additional Parameters Refresh timer running in the 5G ProSe UE-to-Network Relay, which is not limited herein.
S1005: The 5G ProSe UE-to-Network Relay having detected new or updated additional parameters.

In some embodiments, the 5G ProSe UE-to-Network Relay detects new or updated additional parameters, for example, the 5G ProSe UE-to-Network Relay detects new parameter(s), which is not limited herein.
S1006: Sending Relay Additional Information.

In some embodiments, sending Relay Additional Information may be, for example, through Relay Additional Information provisioning, which is not limited herein.

In some embodiments, Relay Additional Information provisioning may be, for example, a Relay Additional Information provisioning message, which is not limited herein.

In some embodiments, when new or updated additional parameters are detected in S1005, the 5G ProSe UE-to-Network Relay is triggered to immediately send a Relay Additional Information provisioning message to the 5G ProSe Remote UE that requested provision of additional parameters to provide the additional parameters, and optionally periodically repeat this at the configurable sending frequency in S1004 until the Additional_Parameters_Refresh Timer expires or there is no UE requesting provision of additional parameters, for example, until the Additional_Parameters_Refresh Timer in the 5G ProSe UE-to-Network Relay expires, which is not limited herein.

In some embodiments, after receiving the Relay Additional Information, the Remote UE may return a corresponding response message to the Relay UE, which is not limited herein.

FIG. 11 is a schematic structural diagram of a communication apparatus according to an embodiment of the present disclosure. The communication apparatus 110 shown in FIG. 11 may include a transceiver module 1101 and a processing module 1102. The transceiver module 1101 may include a sending module and/or a receiving module, where the sending module is used to implement a sending function, and the receiving module is used to implement a receiving function. The transceiver module 1101 may implement the sending function and/or the receiving function.

The communication apparatus 110 may be a terminal (such as the first terminal or the second terminal in the foregoing method embodiments), or an apparatus in a terminal, or an apparatus that can be used in conjunction with a terminal.

The communication apparatus 110, on the first terminal side, includes:
a transceiver module 1101, used to, in response to determining that a first condition is met, send additional information to a second terminal in a unicast manner.

In this embodiment, since the first terminal detects whether the first condition is met and sends additional information to the second terminal in a unicast manner in response to determining that the first condition is met, and since both Mode A and Mode B can be supported, and on-demand sending is achieved through the unicast manner to save transmission consumption, and sending additional information is triggered when the first condition is met, the timeliness of sending additional information can be improved, and effective sending of additional information can be supported.

The communication apparatus 110, on the second terminal side, includes:
a transceiver module 1101, used to receive additional information sent by a first terminal in a unicast manner.

In this embodiment, by receiving the additional information sent by the first terminal in the unicast manner, effective reception of additional information can be supported.

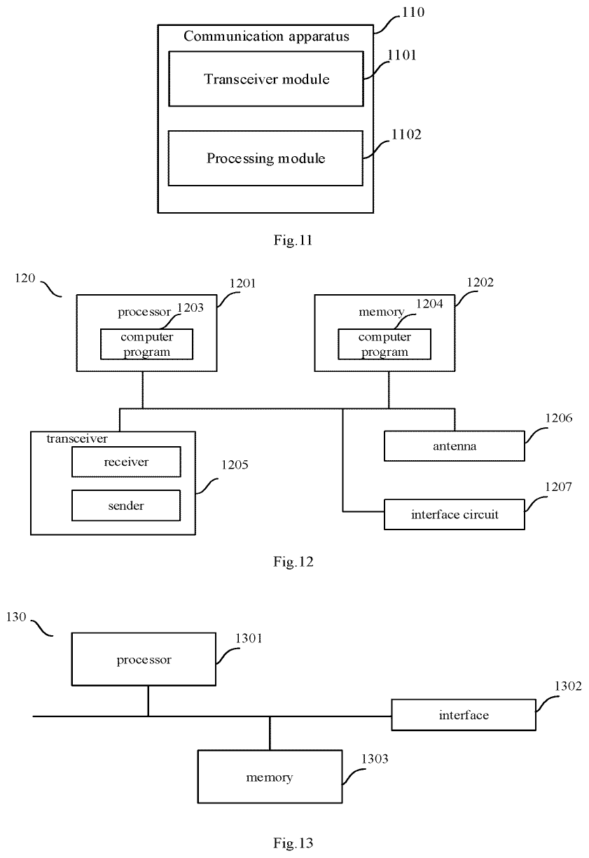

FIG. 12 is a schematic structural diagram of another communication apparatus according to an embodiment of the present disclosure. The communication apparatus 120 may be a terminal (such as the first terminal or the second terminal in the foregoing method embodiments), or a chip, a chip system, or a processor that supports a terminal in implementing the foregoing method. The apparatus may be used to implement the method described in the foregoing method embodiments, and specific reference may be made to the description in the foregoing method embodiments.

The communication apparatus 120 may include one or more processors 1201. The processor 1201 may be a general-purpose processor or a special-purpose processor, etc. For example, it may be a baseband processor or a central processing unit. The baseband processor may be used to process communication protocols and communication data, and the central processing unit may be used to control the communication apparatus (such as a base station, a baseband chip, a terminal device, a terminal device chip, a DU, or a CU), execute computer programs, and process data of the computer programs.

Optionally, the communication apparatus 120 may further include one or more memories 1202, on which a computer program 1204 may be stored. The processor 1201 may store a computer program 1203. The processor 1201 executes the computer program 1204 and/or the computer program 1203 to cause the communication apparatus 120 to perform the method described in the foregoing method embodiments.

Optionally, data may also be stored in the memory 1202. The communication apparatus 120 and the memory 1202 may be separately provided or integrated together.

Optionally, the communication apparatus 120 may further include a transceiver 1205 and an antenna 1206. The transceiver 1205 may be referred to as a transceiver unit, a transceiver, or transceiver circuitry, etc., and is used to implement a transceiver function. The transceiver 1205 may include a receiver and a transmitter. The receiver may be referred to as a receiver or receiving circuitry, etc., and is used to implement a receiving function. The transmitter may be referred to as a transmitter or transmitting circuitry, etc., and is used to implement a sending function.

Optionally, the communication apparatus 120 may further include one or more interface circuits 1207. The interface circuit 1207 is used to receive code instructions and transmit them to the processor 1201. The processor 1201 runs the code instructions to cause the communication apparatus 120 to perform the method described in the foregoing method embodiments.

In one implementation, the processor 1201 may include a transceiver for implementing receiving and sending functions. For example, the transceiver may be transceiver circuitry, an interface, or an interface circuit. The transceiver circuitry, interface, or interface circuit for implementing the receiving and sending functions may be separate or integrated together. The aforementioned transceiver circuitry, interface, or interface circuit may be used for reading and writing code/data, or may be used for transmitting or passing signals.

In one implementation, the processor 1201 may store a computer program 1203. The computer program 1203 runs on the processor 1201 to cause the communication apparatus 120 to perform the method described in the foregoing method embodiments. The computer program 1203 may be solidified in the processor 1201. In this case, the processor 1201 may be implemented by hardware.

In one implementation, the communication apparatus 120 may include circuitry, and the circuitry may implement the functions of sending, receiving, or communication in the foregoing method embodiments. The processor and transceiver described in the present disclosure may be implemented on an integrated circuit (IC), an analog IC, a radio frequency integrated circuit (RFIC), a mixed-signal IC, an application-specific integrated circuit (ASIC), a printed circuit board (PCB), an electronic device, etc. The processor and transceiver may also be manufactured using various IC process technologies, such as complementary metal oxide semiconductor (CMOS), NMOS, PMOS, bipolar junction transistor (BJT), bipolar CMOS (BiCMOS), silicon germanium (SiGe), gallium arsenide (GaAs), etc.

The communication apparatus described in the above embodiments may be a terminal (such as the first terminal or the second terminal in the foregoing method embodiments), but the scope of the communication apparatus described in the present disclosure is not limited thereto, and the structure of the communication apparatus is not limited by FIG. 12. The communication apparatus may be an independent device or may be part of a larger device. For example, the communication apparatus may be:
(1) an independent IC, or chip, or chip system or subsystem;
(2) a set of one or more ICs, optionally, the set of ICs may also include storage components for storing data and computer programs;
(3) an ASIC, such as a modem (Modem);
(4) a module that can be embedded in other devices;
(5) a receiver, terminal device, smart terminal device, cellular phone, wireless device, handset, mobile unit, vehicle-mounted device, network device, cloud device, artificial intelligence device, etc.;
(6) others, etc.

For the case where the communication apparatus is a chip or chip system, reference may be made to FIG. 13. FIG. 13 is a schematic structural diagram of a chip according to an embodiment of the present disclosure. The chip shown in FIG. 13 includes a processor 1301 and an interface 1302. The number of processors 1301 may be one or more, and the number of interfaces 1302 may be multiple.

For the case where the chip is used to implement the functions of the terminal (such as the first terminal or the second terminal in the foregoing method embodiments) in the embodiments of the present disclosure:

The processor 1301 is used to implement the various steps in FIG. 2 to FIG. 10, etc.

Optionally, the chip further includes a memory 1303, and the memory 1303 is used to store necessary computer programs and data.

Those skilled in the art may also understand that the various illustrative logical blocks and steps listed in the embodiments of the present disclosure may be implemented by electronic hardware, computer software, or a combination of both. Whether such functions are implemented by hardware or software depends on the specific application and design constraints of the overall system. Those skilled in the art may use various methods to implement the described functions for each specific application, but such implementation should not be understood as beyond the scope of the embodiments of the present disclosure.

The embodiments of the present disclosure further provide a communication system, where the system includes the communication apparatus of the foregoing embodiments as a terminal (such as the first terminal or the second terminal in the foregoing method embodiments), or the system includes the communication apparatus of the FIG. 12 embodiment as a terminal (such as the first terminal or the second terminal in the foregoing method embodiments).

The present disclosure further provides a readable storage medium having instructions stored thereon, where when the instructions are executed by a computer, the functions of any of the foregoing method embodiments are implemented.

The present disclosure further provides a computer program product, where when the computer program product is executed by a computer, the functions of any of the foregoing method embodiments are implemented.

In the foregoing embodiments, the implementation may be entirely or partially by software, hardware, firmware, or any combination thereof. When implemented by software, it may be entirely or partially in the form of a computer program product. The computer program product includes one or more computer programs. When the computer program is loaded and executed on a computer, the processes or functions described in the embodiments of the present disclosure are entirely or partially generated. The computer may be a general-purpose computer, a special-purpose computer, a computer network, or other programmable devices. The computer program may be stored in a computer-readable storage medium or transmitted from one computer-readable storage medium to another computer-readable storage medium. For example, the computer program may be transmitted from a website site, computer, server, or data center to another website site, computer, server, or data center by wired means (such as coaxial cable, optical fiber, digital subscriber line (DSL)) or wireless means (such as infrared, wireless, microwave, etc.). The computer-readable storage medium may be any available medium that can be accessed by a computer or a data storage device such as a server or data center integrated with one or more available media. The available medium may be a magnetic medium (e.g., floppy disk, hard disk, magnetic tape), an optical medium (e.g., digital video disc (DVD)), or a semiconductor medium (e.g., solid state disk (SSD)), etc.

Those of ordinary skill in the art may understand that the various numerical references such as first, second, etc. in the present disclosure are only for convenience of description and are not intended to limit the scope of the embodiments of the present disclosure, nor do they indicate a sequence.

“At least one” in the present disclosure may also be described as “one or more”, and “multiple” may be two, three, four, or more, which is not limited in the present disclosure. In the embodiments of the present disclosure, for a technical feature, terms such as “first”, “second”, “third”, “A”, “B”, “C”, and “D” are used to distinguish the technical features within that technical feature. The technical features described by “first”, “second”, “third”, “A”, “B”, “C”, and “D” have no sequential or size order.

The correspondence shown in the various tables in the present disclosure may be configured or predefined. The values of the information in the tables are only examples and may be configured to other values, which is not limited in the present disclosure. When configuring the correspondence between information and parameters, it is not necessarily required to configure all the correspondences shown in the tables. For example, in the tables of the present disclosure, the correspondences shown in some rows may not be configured. Also, for example, appropriate adjustments may be made based on the above tables, such as splitting, merging, etc. The parameter names shown in the titles of the above tables may also be other names understandable by the communication apparatus, and the values or representations of the parameters may also be other values or representations understandable by the communication apparatus. The above tables may be implemented using other data structures, such as arrays, queues, containers, stacks, linear lists, pointers, linked lists, trees, graphs, structures, classes, heaps, hash tables, or hash maps.

“Predefined” in the present disclosure may be understood as defined, predefined, stored, pre-stored, pre-negotiated, pre-configured, solidification, or pre-burned.

The embodiments of the present disclosure are not exhaustive, but are only illustrative of some embodiments, and do not specifically limit the protection scope of the present disclosure. In case of no conflict, each step in a certain embodiment may be implemented as an independent embodiment, and the steps may be combined arbitrarily. For example, the solution after removing some steps in a certain embodiment may also be implemented as an independent embodiment, and the order of the steps in a certain embodiment may be arbitrarily exchanged. In addition, the optional implementation manners in a certain embodiment may be arbitrarily combined. Furthermore, the embodiments may be arbitrarily combined. For example, part or all of the steps of different embodiments may be arbitrarily combined, and a certain embodiment may be arbitrarily combined with the optional implementation manners of other embodiments.

In the embodiments of the present disclosure, if there is no special explanation and logical conflict, the terms and/or descriptions in the embodiments are consistent and can be referred to each other, and the technical features in different embodiments can be combined to form new embodiments according to their internal logical relationships.

The terms used in the embodiments of the present disclosure are for the purpose of describing particular embodiments only and are not intended to limit the present disclosure.

In the embodiments of the present disclosure, unless otherwise stated, the elements expressed in singular form, such as “a”, “an”, “the”, “the above”, “said”, “the foregoing”, “this”, etc., may represent “one and only one” or “one or more”, “at least one”, etc. For example, when using articles such as “a”, “an”, “the” in translation, the noun following the article may be understood as singular or plural.

In the embodiments of the present disclosure, “multiple” means two or more.

In some embodiments, “at least one of”, “one or more”, “a plurality of”, “multiple”, etc. may be used interchangeably.

In some embodiments, expressions such as “at least one of A and B”, “A and/or B”, “in one case A, in another case B”, “in response to one case A, in response to another case B”, etc., may include the following technical solutions: in some embodiments A (performing A regardless of B); in some embodiments B (performing B regardless of A); in some embodiments, selecting to perform A or B (A and B are selectively performed); in some embodiments A and B (both A and B are performed). When there are more branches such as A, B, C, etc., it is similar to the above.

In some embodiments, expressions such as “A or B”, etc., may include the following technical solutions: in some embodiments A (performing A regardless of B); in some embodiments B (performing B regardless of A); in some embodiments, selecting to perform A or B (A and B are selectively performed). When there are more branches such as A, B, C, etc., it is similar to the above.

The prefix terms such as “first”, “second”, etc. in the embodiments of the present disclosure are only used to distinguish different described objects and do not impose limitations on the position, order, priority, quantity, or content of the described objects. The description of the described objects refers to the description in the claims or the context of the embodiments, and should not be construed as imposing additional limitations due to the use of prefix terms. For example, if the described object is a “field”, the ordinal numbers before “field” in “first field” and “second field” do not limit the position or order of the “fields”, and “first” and “second” do not limit whether the “fields” they modify are in the same message, nor do they limit the sequence of “first field” and “second field”. Another example, if the described object is a “level”, the ordinal numbers before “level” in “first level” and “second level” do not limit the priority between the “levels”. Another example, the number of described objects is not limited by the ordinal numbers. For example, taking “first apparatus” as an example, the number of “apparatus” may be one or more. In addition, objects modified by different prefix terms may be the same or different. For example, if the described object is an “apparatus”, “first apparatus” and “second apparatus” may be the same apparatus or different apparatuses, and their types may be the same or different. Another example, if the described object is “information”, “first information” and “second information” may be the same information or different information, and their content may be the same or different.

In some embodiments, “including A”, “containing A”, “used to indicate A”, “carrying A”, may be interpreted as directly carrying A, or indirectly indicating A.

In some embodiments, terms such as “in response to . . . ”, “in response to determining . . . ”, “in the case of . . . ”, “when . . . ”, “if . . . ”, etc. may be used interchangeably.

In some embodiments, terms such as “greater than”, “greater than or equal to”, “not less than”, “more than”, “more than or equal to”, “not less than”, “higher than”, “higher than or equal to”, “not lower than”, “above”, etc. may be used interchangeably. Terms such as “less than”, “less than or equal to”, “not greater than”, “less than”, “less than or equal to”, “not more than”, “lower than”, “lower than or equal to”, “not higher than”, “below”, etc. may be used interchangeably.

In some embodiments, “terminal”, “terminal device”, “user equipment (UE)”, “user terminal”, “mobile station (MS)”, “mobile terminal (MT)”, “subscriber station”, “mobile unit”, “subscriber unit”, “wireless unit”, “remote unit”, “mobile device”, “wireless device”, “wireless communication device”, “remote device”, “mobile subscriber station”, “access terminal”, “mobile terminal”, “wireless terminal”, “remote terminal”, “handset”, “user agent”, “mobile client”, “client”, etc. may be used interchangeably.

In some embodiments, an access network device, a core network device, or a network device may be replaced by a terminal. For example, for a structure where communication between an access network device, a core network device, or a network device and a terminal is replaced by communication between multiple terminals (for example, which may also be called device-to-device (D2D), vehicle-to-everything (V2X), etc.), the various embodiments of the present disclosure may also be applied. In this case, the terminal may have all or part of the functions of the access network device. In addition, terms such as “uplink”, “downlink”, etc. may be replaced by terms corresponding to inter-terminal communication (for example, “side”). For example, an uplink channel or downlink channel may be replaced by a side channel, and an uplink link or downlink link may be replaced by a side link.

In some embodiments, a terminal may be replaced by an access network device, a core network device, or a network device. In this case, the access network device, core network device, or network device may have all or part of the functions of the terminal.

In some embodiments, “determining” may be interpreted as judging, deciding, determining, calculating, computing, processing, deriving, investigating, searching, looking up, inquiring, ascertaining, receiving, transmitting, inputting, outputting, accessing, resolving, selecting, choosing, establishing, comparing, “assuming”, “expecting”, “considering”, broadcasting, notifying, communicating, forwarding, configuring, reconfiguring, allocating, mapping, assigning, etc., but not limited thereto.

Those of ordinary skill in the art may realize that the units and algorithm steps of the examples described in combination with the embodiments disclosed herein can be implemented by electronic hardware, or a combination of computer software and electronic hardware. Whether these functions are performed by hardware or software depends on the specific application and design constraints of the technical solution. Professional technicians may use different methods for each specific application to implement the described functions, but such implementation should not be considered beyond the scope of the present disclosure.

Those skilled in the art may clearly understand that for the convenience and conciseness of description, the specific working processes of the systems, apparatuses, and units described above may refer to the corresponding processes in the foregoing method embodiments, and will not be repeated here.

The above is only specific embodiments of the present disclosure, but the protection scope of the present disclosure is not limited thereto. Any person skilled in the art can easily think of changes or substitutions within the technical scope disclosed in the present disclosure, which should be covered within the protection scope of the present disclosure. Therefore, the protection scope of the present disclosure should be subject to the protection scope of the claims.

1. A method for sending information, performed by a first terminal, comprising:
in response to determining that a first condition is met, sending additional information to a second terminal in a unicast manner.

2. The method according to claim 1, wherein the additional information comprises at least one of:
a temporary mobile group identity (TMGI);
a cell global identifier (CGI), or
a tracking area identity (TAI).

3. The method according to claim 1, wherein determining that the first condition is met comprises at least one of:
the additional information is obtained;
updated additional information is obtained;
a first mode is not configured, wherein the first mode is a mode of broadcasting information of a local terminal for use by other terminals;
a first request message sent by the second terminal is received, wherein the first request message is used to request obtaining the additional information and/or indicate a sending manner of the additional information to the first terminal;
a second request message sent by the second terminal is received, wherein the second request message is used to request sending the additional information to the second terminal in the unicast manner; or
a third request message sent by a third terminal is received, wherein the third request message is at least used to instruct sending the additional information to the second terminal.

4. The method according to claim 1, further comprising:
receiving a first request message sent by the second terminal, wherein the first request message is used to request obtaining the additional information and/or indicate a sending manner of the additional information to the first terminal.

5. The method according to claim 1, further comprising:
receiving a second request message sent by the second terminal, wherein the second request message is used to request sending the additional information to the second terminal in the unicast manner.

6. The method according to claim 1, further comprising:
receiving a third request message sent by a third terminal, wherein the third request message is used to instruct sending the additional information to the second terminal, request obtaining the additional information, and indicate a sending manner of the additional information to the first terminal.

7. The method according to claim 4, wherein the sending manner comprises at least one of:
sending the additional information to the second terminal in the unicast manner;
sending the additional information to all terminals using a same relay service code (RSC) based on a discovery procedure of a first mode, wherein the first mode is a mode of broadcasting information of a local terminal for use by other terminals;
sending the additional information to all terminals using a same RSC based on a discovery procedure of a second mode, wherein the second mode is a mode of sending, in response to a request, information of a terminal from which a response is expected; or
sending the additional information to all terminals using a same RSC based on discovery procedures of a first mode and a second mode.

8. The method according to claim 4, further comprising:
sending a response message related to the first request message to the second terminal, wherein the response message is used to send the additional information.

9. The method according to claim 1, further comprising:
sending a new message to the second terminal, wherein the new message is used to send the additional information; or
sending the additional information in a broadcast manner in response to determining that a second condition is met.

10. (canceled)

11. The method according to claim 9, wherein determining that the second condition is met comprises at least one of:
determining sending the additional information in the broadcast manner based on a sending manner of the additional information indicated by a terminal, wherein the terminal is the second terminal or another terminal; or
not configuring a first mode.

12. The method according to claim 1, further comprising:
indicating a timing duration to the second terminal.

13. The method according to claim 3, wherein sending the additional information to the second terminal comprises:
determining that a time elapsing after receiving the first request message, or the second request message, or the third request message does not reach a timing duration; and
sending the additional information to the second terminal multiple times according to a sending period, wherein the sending period is less than a timing duration.

14. A method for receiving information, performed by a second terminal, comprising:
receiving additional information sent by a first terminal in a unicast manner.

15. The method according to claim 14, wherein the additional information comprises at least one of:
a temporary mobile group identity (TMGI);
a cell global identifier (CGI); or
a tracking area identity (TAI).

16. The method according to claim 14, further comprising:
sending a first request message to the first terminal, wherein the first request message is used to request obtaining the additional information and/or indicate a sending manner of the additional information to the first terminal.

17. The method according to claim 16, further comprising:
receiving a response message related to the first request message sent by the first terminal, wherein the response message is used to send the additional information; or
wherein the sending manner comprises at least one of:
sending the additional information to the second terminal in the unicast manner;
sending the additional information to all terminals using a same relay service code (RSC) based on a discovery procedure of a first mode, wherein the first mode is a mode of broadcasting information of a local terminal for use by other terminals;
sending the additional information to all terminals using a same RSC based on a discovery procedure of a second mode, wherein the second mode is a mode of sending, in response to a request, information of a terminal from which a response is expected; or
sending the additional information to all terminals using a same RSC based on discovery procedures of a first mode and a second mode.

18. The method according to claim 14, further comprising:
sending a second request message to the first terminal, wherein the second request message is used to request sending the additional information to the second terminal in the unicast manner.

19. (canceled)

20. The method according to claim 14, further comprising:
receiving a new message sent by the first terminal, wherein the new message is used to send the additional information; or
receiving the additional information sent by the first terminal in a broadcast manner; or
receiving a timing duration indicated by the first terminal; or
receiving the additional information sent multiple times by the first terminal according to a sending period, wherein the sending period is less than a timing duration.

21-25. (canceled)

26. A communication device, comprising:
one or more processors;
wherein the one or more processors are configured to:
in response to determining that a first condition is met, send additional information to a second terminal in a unicast manner.

27-28. (canceled)

29. A communication device, comprising:
one or more processors;
wherein the one or more processors are configured to invoke instructions to cause the communication device to perform the method according to claim 14.
